(19) United States
(12) Patent Application Publication
(10) Pub. No.: US 2022/0053805 A1
(43) Pub. Date: Feb. 24, 2022

(54) DRIED SEAWEED CRISPS AND METHOD FOR PREPARING SAME

(71) Applicant: CJ CHEILJEDANG CORPORATION, Jung-gu, Seoul (KR)

(72) Inventors: Eun Sun PARK, Songpa-gu, Seoul (KR); Ho Min MYUNG, Dongdaemun-gu, Seoul (KR); Seung Eun PARK, Songpa-gu, Seoul (KR); Na Ri SHIN, Guro-gu, Seoul (KR); Da Woon JEONG, Songpa-gu, Seoul (KR)

(73) Assignee: CJ CHEILJEDANG CORPORATION, Jung-gu, Seoul (KR)

(21) Appl. No.: 17/293,538

(22) PCT Filed: Sep. 18, 2019
(86) PCT No.: PCT/KR2019/012092

§ 371 Date: Nov. 12, 2021

(30) Foreign Application Priority Data
Nov. 16, 2018 (KR) 10-2018-0141933

(51) Int. Cl. A23L 17/60; A23P 30/10; A23L 5/10; A23L 7/10

(52) U.S. Cl. CPC A23L 17/60; A23P 30/10; A23V 2002/00; A23L 7/10; A23L 5/15

(57) ABSTRACT

The present invention relates to a dried seaweed snack and a method for preparing the same.

### TECHNICAL FIELD

The present invention relates to a dried seaweed snack and a method for preparing the same.

### BACKGROUND ART

South Korea surrounded by water on three sides and having relatively rich marine and coastal biological resources has a total production of seaweeds produced on the domestic coast of about 2 million tons. As such, seaweed is a food material that can be obtained in a very rich quantity in South Korea, and has been widely used since ancient times because it is rich in vitamins and minerals essential for health in terms of nutrition.

In particular, seaweed is effective in preventing adult diseases in that it contains vegetable fiber. Ions generated from seaweed are necessary for metabolism because they are combined with acidic waste products in the body and discharged. Therefore, the ions generated from seaweed have a first direct discharge effect of waste products and a second effect of removing toxicity that may be caused by such waste products. In addition, alginic acid, which is contained in large amounts in seaweed, is effective in relieving constipation by helping the peristalsis of the large intestine; calcium ions are effective in preventing osteoporosis or osteomalacia; iodine component is effective in promoting appetite and preventing thyroid swelling.

Conventionally, such seaweed has been consumed uncooked as a raw material for seasoned or simmered foods or in a dried state in the form of a thin sheet of a certain size when long-term distribution or storage is required. As such, seaweed has been mainly distributed as raw materials that require secondary processing or cooking. There have been few examples provided in processed food forms that can be conveniently and immediately consumed.

In recent years, as the health and functional effects of various physiologically active substances contained in seaweed, including vitamins and minerals, have been revealed, seaweed consumption is gradually increasing. In addition, as the preferences of modern people change, the development of high-order processed products using these seaweeds is becoming active. Accordingly, there is a need to spur the development of snacks using seaweed in keeping with this.

### DISCLOSURE OF THE INVENTION

### Technical Problem

The present invention is to provide a dried seaweed snack through which seaweeds that can be easily obtained and have excellent nutrients can be conveniently consumed, and a method for preparing the same.

### Technical Solution

According to one aspect of the present invention, there is provided a dried seaweed snack comprising at least one layer of a joined body in which at least one layer of a dried seaweed sheet and at least one layer of a grain sheet are bonded to each other, wherein the joined body has a hardness of 1500 g to 6000 g and an average water content per 1 cm² unit area of 2.0 wt % or less.

According to another aspect of the present invention, there is also provided a method for preparing a dried seaweed snack, the method comprising: preparing a joined sheet by bonding at least one layer of a dried seaweed sheet and at least one layer of a grain sheet; and preparing a joined body by roasting the joined sheet at a temperature of 175° C. to 185° C. for 5 minutes to 10 minutes.

### Advantageous Effects

The dried seaweed snack according to the present invention is in a form that allows easy consumption of seaweed in a state in which its unique flavor and nutrients are well preserved. In addition, it is processed in a state bonded to a grain sheet to add a crispy texture. Accordingly, the dried seaweed snack according to the invention can provide seaweed in a form that more suits the dietary habits and preferences of modern people.

However, the effects of the present invention are not limited to the above-mentioned effects and other effects not mentioned will be clearly understood from the following description by a person skilled in the art.

### BRIEF DESCRIPTION OF THE DRAWINGS

FIG. 1 sequentially shows a process for preparing a conical shaped dried seaweed snack using laver in the form of a sheet and a rice paper.

### MODE FOR CARRYING OUT THE INVENTION

Hereinafter, the present invention will be specifically described.

The present invention provides a dried seaweed snack and a method for preparing the same.

The dried seaweed snack of the present invention includes at least one layer of a joined body in which at least one layer of a dried seaweed sheet and at least one layer of a grain sheet are bonded to each other.

In one embodiment of the present invention, a joined sheet is prepared by binding at least one layer of the dried seaweed sheet and at least one layer of the grain sheet; the joined body is prepared through a process for roasting the joined sheet.

The dried seaweed sheet is one that is prepared by drying seaweed itself, or fragments thereof, or seaweed flakes or powders in the form of an any-shaped thin sheet. For the seaweed, which is used as a raw material for the dried seaweed sheet, green algae, such as chlorella, green laver, and sea staghorn; red algae, such as laver and agar; brown algae, such as sea mustard, kelp, gulfweed, and hijikia, may be used alone or in combination. As a representative example, laver alone may be dried and used; or laver may be dried together with green laver, chlorella, sea mustard, etc., and used. To further enhance a flavor of the seaweed, various seasonings may be added to the seaweed.

The grain sheet is one that is prepared by mixing grain flakes or powders with water and drying in the form of an any-shaped thin sheet. For the grain, which is used as a raw material for the grain sheet, rice, barley, bean, foxtail millet, proso millet, sorghum, wheat, corn, etc. may be used alone or in combination. In addition, in order to mold the grain flakes or powders into the form of a sheet, starch may be additionally contained in the grain flakes or powders. Various kinds of seasonings may be further added. The grain sheet may be prepared directly from the above-described grain. Commercially available grain sheets such as rice papers may also be used.

The dried seaweed sheet and the grain sheet are bonded to each other to prepare the joined sheet. The joined sheet may be prepared by binding one layer of the dried seaweed sheet and one layer of the grain sheet, respectively, but may be prepared by binding at least one layer of the dried seaweed sheet and at least one layer of the grain sheet, respectively. Herein, at least one aspect of the dried seaweed sheet may be slightly larger than that of the grain sheet. For example, when both the dried seaweed sheet and the grain sheet are circular, the dried seaweed sheet may have a diameter of 3 cm, specifically 2 cm, and more specifically, 1 cm larger than the diameter of the grain sheet. That is, the joined body may be molded in a form in which at least one portion of the joined body overlap each other. The joined body may be molded in a form in which at least one portion of the joined body overlap and attach to each other so that the dried seaweed sheet is exposed to the outside.

In the binding of the dried seaweed sheet and the grain sheet, performed in the process of preparing the joined sheet, the joined sheet may be prepared by applying an adhesive to at least one of at least one layer of the dried seaweed sheet and at least one layer of the grain sheet and bring the dried seaweed sheet in contact with the grain sheet to press. Herein, as the adhesive, a viscous edible liquid, such as water, salt water, sugar solution, starch water, and grain paste, may be used. As the grain paste, wheat flour paste, rice paste, or glutinous rice paste may be used. In addition, the adhesive may contain a minimum of water within a range showing viscosity to improve a crispy texture of a finally prepared dried seaweed snack.

The joined body is prepared by roasting the joined sheet as prepared above. The process for roasting the joined sheet described above is to additionally remove water present in the dried seaweed sheet, the grain sheet, the adhesive, or the like that constitute the joined sheet to achieve a crispy texture in the finally prepared joined body. Therefore, the process for roasting the joined sheet as described above may be performed in a no moisture environment, such as oven, at a temperature condition of 175° C. or more, 177° C. or more, 179° C. or more, or 180° C. or more, and 195° C. or less, 193° C. or less, 191° C. or less, or 190° C. or less, for a time of 3 minutes or more, 4 minutes or more, 5 minutes or more, or 6 minutes or more, and 15 minutes or less, 13 minutes or less, 11 minutes or less, or 9 minutes or less. Where the process for roasting the joined sheet as described above is performed at a temperature condition of less than 175° C. or for a time of fewer than 3 minutes, the moisture in the joined sheet is not sufficiently reduced so that a crispy texture cannot be achieved in the finally prepared joined body. Where the process for roasting the joined sheet as described above is performed at a temperature condition of more than 195° C. or for a time of more than 15 minutes, the seaweed that constitutes the dried seaweed sheet burns.

Meanwhile, in another embodiment, a process for molding the joined sheet by means of a mold may be further performed before roasting the joined sheet as described above. Herein, depending on the shape to be formed, a mold having a shape suitable thereto may be used. The joined sheet may be molded not only in a two-dimensional shape but also in a three-dimensional shape. When the joined sheet is molded in a three-dimensional shape as described above, it may be molded through a mold having an appropriate shape to form space therein. For example, the joined sheet may be molded in a conical shape through a conical-shaped mold by wrapping the joined sheet around the outer circumferential surface of the conical-shaped mold. Herein, the joined sheet may be wrapped around the outer circumferential surface of the mold so that the dried seaweed sheet of the joined sheet is exposed to the outside.

When performing the process for molding the joined sheet as described above, the joined sheet is being prevented from being restored to its original state. In addition, to prepare the joined sheet in its molded form, when wrapping the joined sheet around the outer circumferential surface of the mold as described above, the adhesive may be applied to the overlapping portion of the joined sheet, thereby further binding the joined sheet together. Furthermore, the joined sheet molded through the mold may be roasted together with the mold while being mounted in the mold.

The joined body prepared by roasting with the mold while being mounted in the mold may be cooled while being mounted in the mold, and then it may be separated from the mold. The cooling process as described above is to prevent the joined body from being broken when separating the joined body from the mold. The cooling process may be performed at a temperature condition of 50° C. or less, 40° C. or less, 30° C. or less, or room temperature, for a time of 1 minute or more, 3 minutes or more, 5 minutes or more, or 7 minutes or more, and 20 minutes or less, 17 minutes or less, 15 minutes or less, or 13 minutes or less. After being subjected to the cooling process as described above, the joined body separated from the mold may remain the form molded through the mold as it is.

The joined body prepared as described above may have an average water content per 1 cm² unit area of 2.0 wt % or less, 1.9 wt % or less, 1.8 wt % or less, 1.7 wt % or less, 1.6 wt % or less, 1.5 wt % or less, or 1.4 wt % or less. When the average water content per 1 cm² unit area of the joined body is more than 2.0 wt %, the crispness of the finally prepared dried seaweed snack is insufficient, so the texture deteriorates.

In addition, the joined body may have a hardness of 1500 g or more, 1700 g or more, 1900 g or more, or 2100 g or more, and 6000 g or less, 5800 g or less, 5600 g or less, or 5500 g or less. When the hardness of the joined body is lower than 1500 g, the crispness of the finally prepared dried seaweed snack is insufficient, so the texture deteriorates. When the hardness of the joined body is higher than 6000 g, the finally prepared dried seaweed snack is too hard to consume.

In addition, one side of the joined body may have a chromaticity, of which: L* in the color coordinate (CIE L*a*b*) is 15 or more, 16 or more, 17 or more, or 18 or more, and 30 or less, 28 or less, 26 or less, or 24 or less; a* in the color coordinate is −15 or more, −13 or more, −11 or more, or −10 or more, and 5 or less, 3 or less, 2 or less, or 1 or less; and b* in the color coordinate is −10 or more, −8 or more, −6 or more, or −4 or more, and 10 or less, 8 or less, 7 or less, or 6 or less. The chromaticity of the joined body, especially the L* value in the color coordinate is affected by the conditions of the process for roasting the joined sheet. When the process for roasting the joined sheet is performed at a temperature condition of less than 175° C. or for a time of fewer than 3 minutes, the value in the color coordinate becomes above 30. When the process for roasting the joined sheet is performed at a temperature condition of more than 195° C. or for a time of more than 15 minutes, the seaweed burns, and thus, the L* value in the color coordinate becomes below 15.

Hereinafter, the present invention will be described in detail through Examples.

However, the following Examples specifically illustrate the present invention, and the contents of the present invention are not limited by the following Examples.

### Preparation Example 1

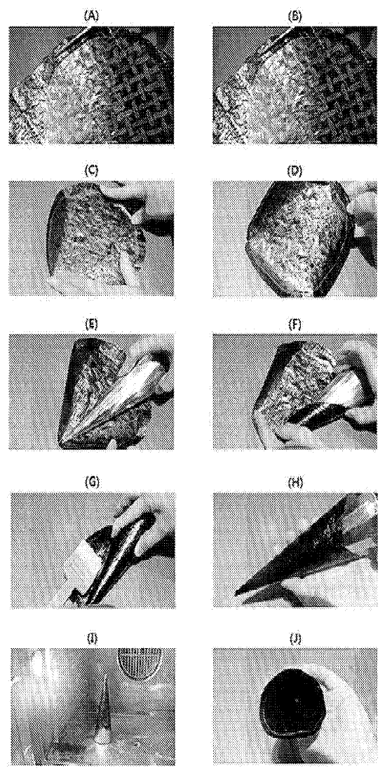

Dried seaweed snack was prepared using laver in the form of a sheet (Bibigo laver for Gimbap) and a rice paper (Mon Vietnam Spring Roll rice paper). More specifically, as shown in FIG. 1, first, a laver sheet having a diameter of about 1 cm larger than the circular rice paper was cut ((A) and (B)). Rice paste was applied to the rice paper. Then, the rice paper was bonded to the cut laver sheet to prepare a joined sheet ((C) and (D)). The Mined sheet prepared as described above was wrapped around a conical-shaped mold so that the laver sheet was exposed to the outside ((E) and (F)). The rice paste was applied to the overlapping portion of the joined sheet to mold the joined sheet in a conical shape ((G) and (H)). The joined sheet molded as described above was placed, with the mold while being mounted in the mold, into an oven and roasted at a temperature of 175° C. to 195° C. for 3 minutes to 15 minutes to prepare a joined body (I). Then, the joined body was allowed to cool at room temperature for 5 minutes and separated from the mold to prepare a conical-shaped dried seaweed snack (J)

### Preparation Example 2

The joined sheet was molded in a conical shape using the conical-shaped mold in the same manner as in Preparation Example 1. The molded joined sheet was placed, with the mold while being mounted in the mold, into the oven and roasted at a temperature of 175° C. to 195° C. for 3 minutes to 15 minutes to prepare a joined body. The joined body was separated from the mold without cooling.

When the joined body was not subjected to the cooling process as described above, it was broken during the separation from the mold and could not remain the conical shape.

### Preparation Example 3

The joined sheet was molded in a conical shape using the conical-shaped mold in the same manner as in Preparation Example 1. The molded joined sheet was placed, with the mold while being mounted in the mold, into the oven and roasted at the temperature of 170° C. for 3 minutes to 15 minutes to prepare a joined body. Then, the joined body was allowed to cool at room temperature for 5 minutes and separated from the mold to prepare a conical-shaped dried seaweed snack.

### Preparation Example 4

The joined sheet was molded in a conical shape using the conical-shaped mold in the same manner as in Preparation Example 1. The molded joined sheet was placed, with the mold while being mounted in the mold, into the oven and roasted at the temperature of 200° C. for 3 minutes to 15 minutes to prepare a joined body. Then, the joined body was allowed to cool at room temperature for 5 minutes and separated from the mold to prepare a conical-shaped dried seaweed snack.

### Preparation Example 5

The joined sheet was molded in a conical shape using the conical-shaped mold in the same manner as in Preparation Example 1. The molded joined sheet was placed, with the mold while being mounted in the mold, into the oven and roasted at a temperature of 175° C. to 195° C. for 2 minutes to prepare a joined body. Then, the joined body was allowed to cool at room temperature for 5 minutes and separated from the mold to prepare a conical-shaped dried seaweed snack.

### Preparation Example 6

The joined sheet was molded in a conical shape using the conical-shaped mold in the same manner as in Preparation Example 1. The molded joined sheet was placed, with the mold while being mounted in the mold, into the oven and roasted at a temperature of 175° C. to 195° C. for 17 minutes to prepare a joined body. Then, the joined body was allowed to cool at room temperature for 5 minutes and separated from the mold to prepare a conical-shaped dried seaweed snack.

### Experimental Example 1

Determination of Water Content in Dried Seaweed Snack

The water content of the dried seaweed snack prepared in Preparation Example 1 was measured. The water content was measured at 105° C. under a normal pressure heating condition in triplicate. The average result value is shown.

TABLE 1

| Rounds | Water content (wt %) |
|---|---|
| 1 | 1.20 |
| 2 | 1.15 |
| 3 | 1.35 |

### Experimental Example 2

Determination of Chromaticity of Dried Seaweed Snack

The chromaticity of the dried seaweed snack prepared in Preparation Example 1 was measured using a color difference meter (JC 801, Color techno system Co, Japan). The values for L* (lightness), a* (redness) and b* (yellowness) were measured total nine times under the same condition. The average value was taken as a result and is shown in Table 2. Herein, the values of the standard white plate used were L*=93.73, a*=−0.12, and b*=0.11.

TABLE 2

| Rounds | L* | a* | b* |
|---|---|---|---|
| 1 | 22.88 | −1.310 | 3.252 |
| 2 | 20.24 | −9.440 | 4.144 |
| 3 | 20.25 | −1.500 | 4.020 |
| 4 | 20.85 | −5.065 | −2.554 |
| 5 | 20.29 | 1.385 | 3.474 |
| 6 | 21.27 | 1.110 | 3.826 |
| 7 | 20.92 | −1.755 | 4.486 |
| 8 | 21.27 | 0.210 | 5.044 |
| 9 | 20.92 | 0.095 | 4.300 |

### Experimental Example 3

Physical Property Analysis of Dried Seaweed Snack

The physical property of the dried seaweed snack prepared in Preparation Example 1 was confirmed by measuring a hardness (g) (a force which is necessary to reach a determined deformation, and is the maximum force of a first bite) using TA-XT Plus (Texture Technologies, UK) that is a physical property analyzer. The hardness was measured total nine times under the same condition and the result is shown in Table 3.

The physical property analyzer mimics an action of bite twice in human mouth. A probe (cylinder metal probe) of the physical property analyzer goes down to a food sample from an adjusted distance at an adjusted speed. Then, the probe goes up to a pre-adjusted distance and goes down again for a second bite. A force-sensing device and a converter recognize a force applied to the sample for measurement and send the data (force value, operation time, probe movement distance) to a computer. Conditions for measuring the physical property are as follows:

<Conditions for Measuring the Physical Property>

Probe: a cylindrical shape having a diameter of 2.5 cm×2.0 cm;

Speed (pre-test speed) at which the probe goes down to a sample: 2.0 mm/sec;

Speed (test speed) at which the probe penetrates the sample after touching the surface of the sample: 2.0 mm/sec;

Speed (post-test speed) at which the probe returns to the original position after penetrating through the sample: 4.0 m/sec;

Distance by which the probe recognizes the surface of the sample and penetrates the sample: 10.0 mm;

Condition (trigger type) under which the probe recognizes the sample: force; 5.0 g.

TABLE 3

| Rounds | Hardness (g) |
|---|---|
| 1 | 2676 |
| 2 | 2173 |
| 3 | 2815 |
| 4 | 4574 |
| 5 | 4867 |
| 6 | 3348 |
| 7 | 4173 |
| 8 | 5106 |
| 9 | 5462 |

Although preferred Preparation Examples of the present invention have been exemplarily described above, the scope of the present invention is not limited to the specific Preparation Examples as described above, a person skilled in the art can change the present invention within the scope described in the claims of the present invention.

1. A dried seaweed snack comprising at least one layer of a joined body in which at least one layer of a dried seaweed sheet and at least one layer of a grain sheet are bonded to each other, wherein the joined body has a hardness of 1500 g to 6000 g and an average water content per 1 cm² unit area of 2.0 wt % or less.

2. The dried seaweed snack of claim 1, wherein the dried seaweed sheet includes at least one selected from the group consisting of chlorella, green laver, sea staghorn, laver, agar, sea mustard, kelp, gulfweed, and hijikia.

3. The dried seaweed snack of claim 1, wherein the grain sheet includes at least one selected from the group consisting of rice, barley, bean, foxtail millet, proso millet, sorghum, wheat, and corn.

4. The dried seaweed snack of claim 1, wherein the joined body further comprises a layer of a bonding agent between at least one layer of the dried seaweed sheet and at least one layer of the grain sheet.

5. The dried seaweed snack of claim 1, wherein the joined body has a hardness of 2100 g to 5500 g and an average water content per 1 cm² unit area of 1.5 wt % or less.

6. The dried seaweed snack of claim 1, wherein one side of the joined body has a chromaticity, of which L* is in a range of 15 to 30, a* is in a range of −15 to 5, and b* is in a range of −10 to 10 in the color coordinate.

7. The dried seaweed snack of claim 6, wherein one side of the joined body has a chromaticity, of which L* is in a range of 18 to 24, a* is in a range of −10 to 1, and b* is in a range of −4 to 6 in the color coordinate.

8. A method for preparing a dried seaweed snack, comprising: preparing a joined sheet by bonding at least one layer of a dried seaweed sheet and at least one layer of a grain sheet; and preparing a joined body by roasting the joined sheet at a temperature of 175° C. to 195° C. for 3 minutes to 15 minutes.

9. The method for preparing a dried seaweed snack of claim 8, wherein the preparing a joined sheet comprises: applying an adhesive to at least one of at least one layer of the dried seaweed sheet and at least one layer of the grain sheet; and bring the dried seaweed sheet in contact with the grain sheet to press.

10. The method for preparing a dried seaweed snack of claim 8, further comprising molding the joined sheet by means of a mold before roasting the joined sheet.

11. The method for preparing a dried seaweed snack of claim 10, wherein the preparing a joined body comprises roasting the joined sheet molded by means of the mold while being mounted in the mold to prepare the joined sheet to a joined body in a form molded by means of the mold.

12. The method for preparing a dried seaweed snack of claim 11, wherein the preparing a joined body further comprises separating the joined body from the mold after cooling the joined body while being mounted in the mold.

13. The method for preparing a dried seaweed snack of claim 12, wherein the cooling is performed at room temperature for 1 minute to 20 minutes.

14. The method for preparing a dried seaweed snack of claim 8, wherein i) the joined body has a hardness of 1500 g to 6000 g, ii) one side of the joined body has a chromaticity, of which L* is in a range of 15 to 30, a* is in a range of −15 to 5, and b* is in a range of −10 to 10 in the color coordinate, and iii) the joined body has an average water content per 1 cm² unit area of 2.0 wt % or less.
